(19) United States
(12) Patent Application Publication
(10) Pub. No.: US 2007/0192130 A1
(43) Pub. Date: Aug. 16, 2007

(54) System and method for rating service providers

(76) Inventor: Haramol Singh Sandhu, Arlington, VA (US)

Correspondence Address: Maier & Maier, PLLC, 1000 Duke St., Alexandria, VA, 22314, US

(21) Appl. No.: 11/700,044

(22) Filed: Jan. 31, 2007

Related U.S. Application Data
(60) Provisional application No. 60/763,695, filed on Jan. 31, 2006.
(60) Provisional application No. 60/777,604, filed on Feb. 28, 2006.

(51) Int. Cl. G06Q 10/00; G06Q 30/00

(52) U.S. Cl. 705/1

(57) ABSTRACT

A method and system to search for and compare service providers. A database may be searched by a potential service buyer and results may be returned. The results may be listed in such a manner as to reflect one or more of a variety of ratings techniques. The ratings applied to the service providers may take into account past information about jobs completed by the service provider as well as past information about the parties performing the ratings of the service providers.

### CROSS REFERENCE TO RELATED APPLICATIONS

This application claims priority under 35 U.S.C. §119(e) of U.S. Provisional Application 60/763,695, filed Jan. 31, 2006 and U.S. Provisional Application 60/777,604, filed Feb. 28, 2006, the entire contents of both of which are hereby incorporated by reference.

### FIELD OF THE INVENTION

This invention relates generally to a system and method for accessing a database and more specifically to searching for a service provider, obtaining services from a service provider and rating the performance of the service provider.

### BACKGROUND

There have been many ways in which consumers have sought out and learned about the services provided by service providers in the past. Simple word of mouth is often used, as are phone books and other readily available resources, such as advertisements. More recently, consumers utilize the Internet to find service providers and learn about their services. Search engines are commonly used in broad searches to help consumers access appropriate parties to provide the desired services.

Traditional resources and Internet searches do not provide the consumers using these research avenues with a meaningful way to rate a service provider's job performance after a job has been completed. Nor is there a useful ratings system in place employed by existing websites that allows a consumer to compare the level of service to expect from two or more service providers before determining who they wish to perform their desired service. Some background sources, Internet search engines and online databases have systems whereby a service provider is given a score or rating of a certain number of stars, a numerical rating of, for example, one through ten, or a letter grade of A through F. These ratings schemes, however, are not useful to consumers and can be misleading.

### SUMMARY OF THE INVENTION

One exemplary embodiment includes a method for providing a rating. The method can include housing information about a plurality of first parties in a database. It may also include searching, by any second party, for a service offered by one of the plurality of first parties. The method may then allow for the accessing, by a second party, of the information about the plurality of first parties. The method can continue by offering a job to one of the first parties by the second party and the first party performing the job. After the job is completed, the method may include the collection of data regarding the job performed by the first party and also the second party assigning a rating to the first party who performed the job based upon the inputted data regarding the job and data about the second party for whom the job was performed.

In another exemplary embodiment, a system is disclosed whereby a party may obtain and rate services. The system can include an online database housing information regarding a plurality of service providers and an online interface that allows users to access the online database and contact the service providers. The online interface may further have a search tool into which users can enter search criteria and the search tool can return search results that are rated and ranked according to data provided by users who previously obtained services from the service providers in the online database and other data regarding the service providers. The system can further include a feedback input mechanism that allows users of the system to leave feedback regarding the service provider's service following the completion of a job, and the feedback may be used as part of the data used in calculating an aggregate value rating of a service provider's services.

Yet another exemplary embodiment describes a method of providing and rating services. This method can include means for housing data regarding a plurality of service providers and means for allowing a plurality of service buyers to access and search the data regarding the plurality of service providers. The method may further have means for returning relevant search results to the plurality of service buyers and means for communicating a job offer from a service buyer to a service provider. In addition, the method can have means for the service buyer to leave feedback data regarding a job performed by the service provider and means for aggregating the feedback provided by the service buyer with feedback provided on other jobs.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary diagram showing a computer system.

FIG. 2 is an exemplary diagram showing exemplary search criteria and results.

FIG. 3 is an exemplary flow chart showing exemplary steps taken by a service buyer.

FIG. 4 is an exemplary flow chart showing steps taken by a service provider.

FIG. 5 is an exemplary diagram showing the layout of search results displayed to a prospective service buyer.

FIG. 6 is an exemplary diagram showing exemplary search criteria and results.

FIG. 7 is an exemplary diagram showing the layout of search results displayed to a prospective service buyer.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

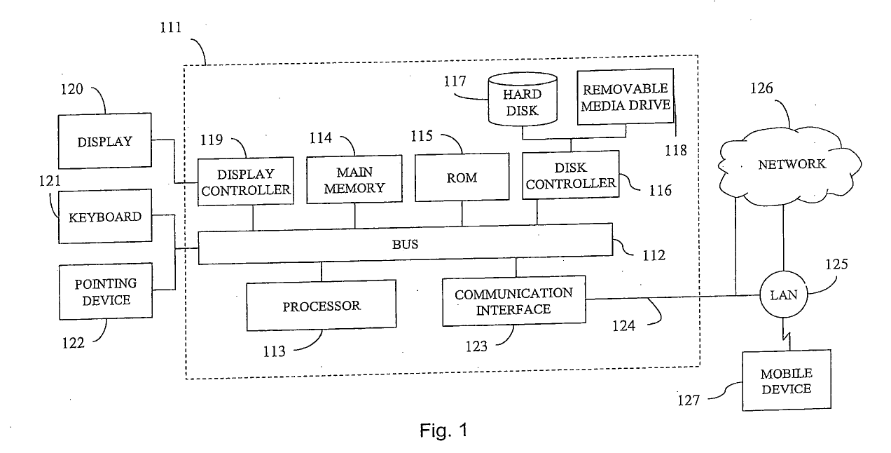

FIG. 1 illustrates a computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system and method known to one having ordinary skill in the art. The databases may be provided, for example, as a database management system (DBMS), a relational database management system (e.g., DB2, ACCESS, etc.), an object-oriented database management system (ODBMS), a file system or another conventional database package as a few non-limiting examples. The databases can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer user. The computer system includes input devices, such as a keyboard 121 and a pointing device 122, for interacting with a computer user and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., a LAN) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

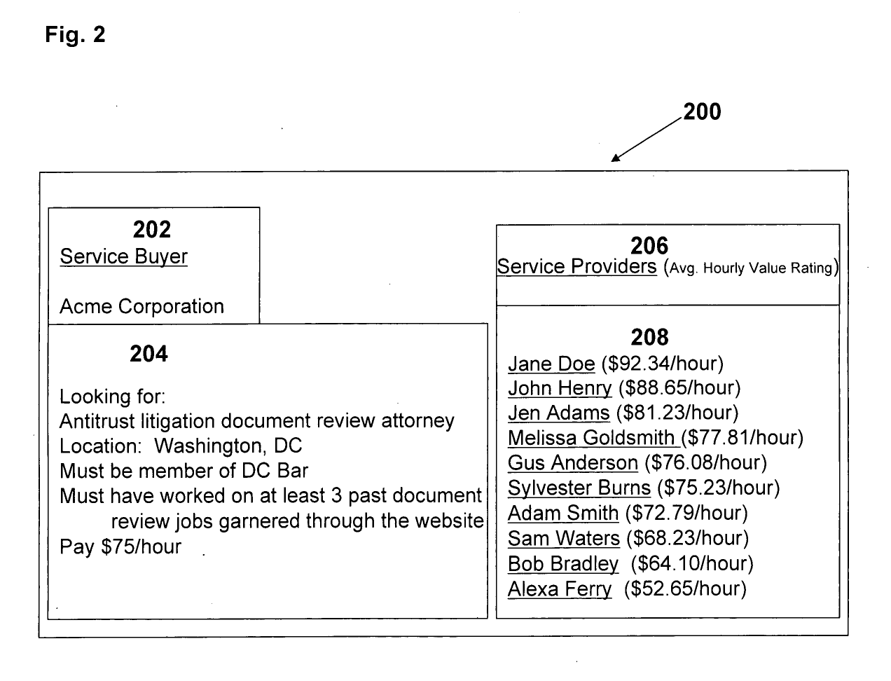

In one exemplary embodiment, a method and system for rating one or more service providers are disclosed. Referring generally to FIGS. 2-7, it can be shown that a party who desires to obtain a service or services from a second party service provider may access a database containing information regarding a variety of service providers. The first party may choose a service provider based on any number of desired criteria and then contact the service provider. At the completion of the service, the first party may provide a rating or ranking to the service provider. This rating or ranking is then combined with previous ratings or rankings to create an aggregate rating or ranking for the service provider.

With respect to FIG. 2, a system and method for providing a ratings score for one or more service providers is described. The interface may be accessed through the use of a computer network, for example the Internet. The system and method can utilize an interface that allows a user or service buyer to browse search a wide variety of service providers through the use of a variety of search criteria. Additionally, the system and method can allow a user or service buyer to browse through listings or postings in any other manner know to those having ordinary skill in the art. The service providers and listings that may be found through the interface can include any type of service, job or product, although several non-limiting examples are referred to herein.

In the exemplary embodiment shown in FIG. 2, a user 202 can access an Internet site or website that allows users 202 to find potential service providers 206. The website may allow the user 202 to browse through all of the listings of service providers 206, categorize the listings 208 and then browse through them or otherwise arrange the listings for viewing. The website may also allow the user 202 to enter search criteria 204 or choose search criteria from a list. The criteria provided by the website may include the location of a job, the date by which a user 202 wants a job started and/or completed, the hourly cost of a job 208, the total cost of a job, the type of job and specific qualifications of a party who is to perform a job. These exemplary categories may be further broken down based upon the desires of the user 202. For example, the location of a job could be designated as local, national or international, because the service may be able to be performed remotely, over the phone, over the Internet, or over any other communication or transmission means known to one having ordinary skill in the art.

Alternatively, the user 202 could specify that the location of the service provider could be within a certain distance of a location, such as specifying only those service providers within 50 miles of Los Angeles, Calif. The category for the type of job desired could be broken down into any job or service that is known, for example law services, masonry, carpentry. These job categories may be further subdivided if, for example, the user knows precisely what type of service he or she requires. Thus, law services, for example, could be subdivided into attorney services or paralegal services, or, alternatively into more specific fields, such as antitrust law, intellectual property law, and the like. Additionally, for fields where it is possible, certain qualifications, skill sets and certifications may be searched. These criteria may be sought in conjunction with another field (e.g. intellectual property attorney and Virginia Bar membership) or may be sought on their own (e.g. Microsoft® certification or Perl, XML or PHP programming skills).

Further, as described above, any one search criteria 204 may be combined with any other single or plural search criteria 204. Thus, any of the exemplary categories described above may be combined with other categories described herein or obvious to one having ordinary skill in the art. Additionally, a user 202 utilizing this system and method can request that the service provider 206 have previously performed services and received ratings through the interface. For example, a user 202 could request that a service provider 206 have performed at least three jobs and received a rating for each of those jobs. The user could further specify what specific fields they want the service provider 206 to have performed the jobs in, that the service provider have performed the jobs and received ratings from separate parties or any other possible criteria.

Thus, in the exemplary output screen 200 shown in FIG. 2, an interface user 202 (the “Acme Corporation”) can be designated as a service recipient. User 202 may choose any search criteria they desire, such as, but not limited to, those discussed above, and enter it into a search engine. In this exemplary embodiment, user 202 has sought a service provider having a variety of qualities, shown in criteria box 204. Specifically, user 202 has sought a DC-barred antitrust litigation document review attorney for a job paying $75 per hour in Washington, D.C., with the additional criteria that the service provider hired must have worked on at least three past document review jobs garnered through the website.

On the right hand side of FIG. 2, the service providers 206 matching the search criteria and their average hourly value ratings are shown. The number of service providers 206 appearing in box 208 may be have a default value, for example ten, may be limited to a certain number, may be adjusted by the user 202, for example having an option to show any number of service providers 206 who meet their criteria or show all of the service providers 206 who meet their criteria. For example, if there are only a few service providers 206 who meet the criteria searched for by the user, all of the matching service providers may appear. If, however, there are more service providers 206 who meet the user's 202 search criteria than the amount that are to be displayed in box 208, a manner of showing the additional result may be provided on the interface, such as a hyperlink to show all of the matches or to show the next set of matches. The average hourly value rating 208, the calculation of which is explained in detail below, or any other rating may be used as the ordering mechanism for the results. For example, the results may be ordered so that the service provider with the highest average hourly value rating appears first in the results, the service provider 206 with the lowest average hourly value rating may appear first in the results, or any other ordering scheme known to one having ordinary skill in the art may be utilized to show the results of the search performed by the user.

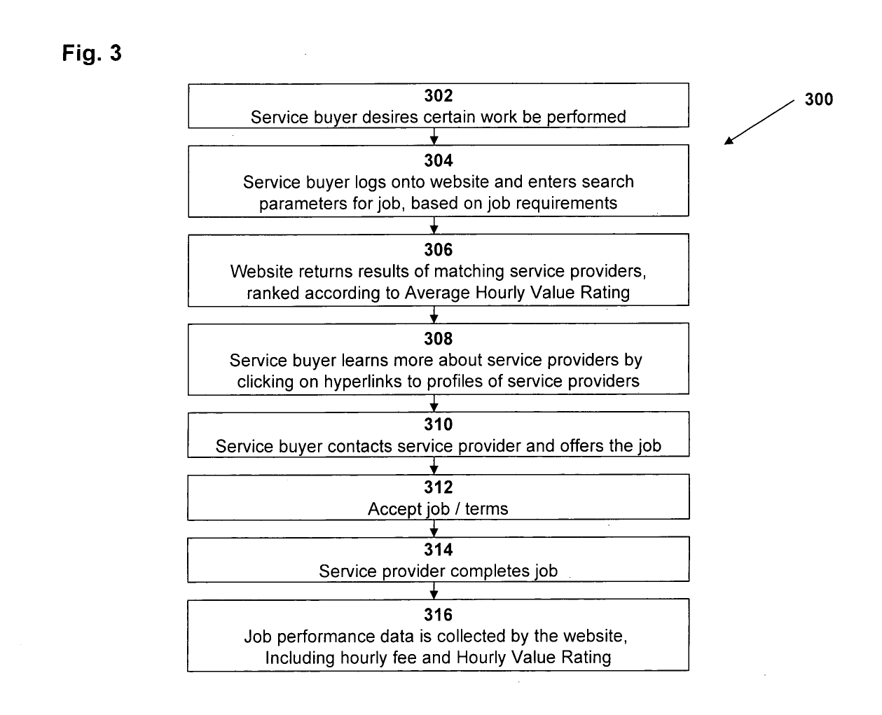

In another exemplary embodiment shown in FIG. 3, a flowchart 300 can be used to describe the interaction between a user of the interface or service buyer 202, the interface and a service provider. First, in step 302, a user 202 may determine that he or she needs to obtain a service, such as a job to be performed, or, alternatively, that he or she needs to obtain a product. Thus, in step 304, the user 202 may log onto a website housing the service provider interface. The website may be such that a user 202 can immediately and anonymously perform searches. Alternatively, the user 202 may have to register with the website and create or obtain log in information before they perform any searches. In a further exemplary embodiment, a user 202 may have to pay a registration fee before being able to perform searches. However, once the user 202 has logged in, the user 202 may enter search parameters that they desire to perform the desired job or obtain the desired product.

After searching the appropriate database or databases, in step 306, the website may display the results 208 of the user's 202 search. The results 208 can include matching service providers 206 who are ranked according to their respective average hourly value ratings. Additionally, as described above, the service providers 206 may be ranked or displayed in any other of a variety of manners. Additionally, the ranking and displaying of the service providers 206 may include hyperlinks associated with each of the service providers 206. After viewing the list, the user 202, in step 308, may obtain more information about one or more service providers 206 by clicking hyperlinks associated with the names of the service providers 206. The hyperlinks may lead to outside websites owned and maintained by the service providers 206 or may lead to profile pages that are part of the interface and which may contain a variety of information. The profile pages may contain, for example, information about past jobs performed, biographical data and skill-related information. Other data related to past jobs may also be available. This data can include average hourly value ratings, average actual hourly fees, total compensation earned, total hours worked and/or billed and any other information about one or more particular jobs. Depending on the application, all of the information that may be housed on the profile pages may or may not be available to all users 202 of the website at all times. In other exemplary embodiments, the information available to users 202 of the website may be limited to a predetermined amount and scope of data.

Additionally, a service provider 206 may have one or more profiles that may be accessible from a first profile page or may be accessible depending on the search criteria used by a potential service buyer. For example, a service provider 206 can have multiple profiles or sub-profiles if that service provider performs jobs in more than one category or subcategory. As a non-limiting example, a service provider 206 may have one profile as a carpenter and a separate or different profile as a mason. Also, jobs within a broad category may be further subdivided into multiple subcategories. As one example, real estate agent jobs may be divided into subcategories reflective of different market value ranges of the property sold or by different types of properties sold. Similarly, with respect to carpentry work, different subcategories may include “small woodwork”, “simple structural work” and “whole house or building work.”

After learning about the service providers that meet the user's 202 criteria in step 308, the user 202 may choose to contact a service provider in step 310. Contacting the service provider 206 can further include the offering of a job to the service provider 206. If the service provider 206 accepts the job, in step 312, they may begin performance. Alternatively, if the contacted service provider 206 refuses the job, the user 202 may proceed back to step 310 and contact another service provider.

After completing the job in step 314, the association between the service provider 206 and the user 202 of the interface is concluded. However, in step 316, the user of the interface may rate the service provider based upon the job performance and the job performance data can be collected, interpreted and aggregated with other data regarding the job, including both actual fee data for the job and hourly value rating data. This data is then incorporated into the website and interface and used to help rate and rank the service provider in future searches.

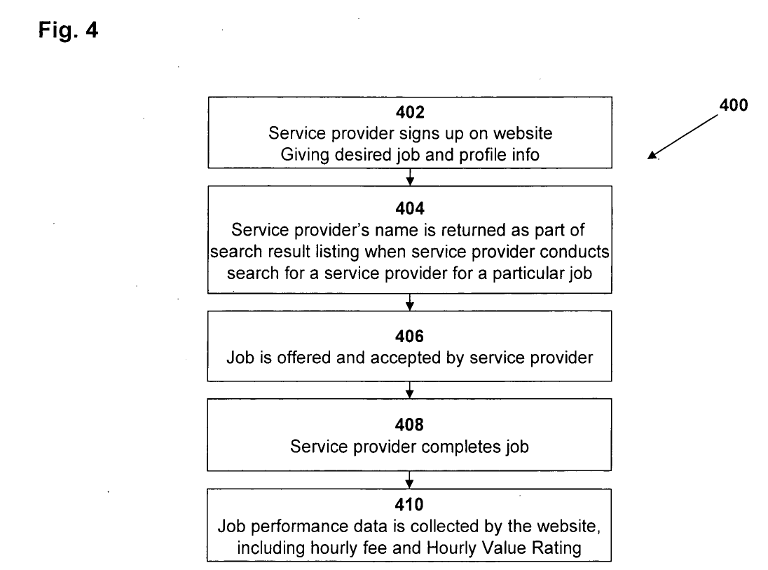

In another exemplary embodiment shown in FIG. 4, the interaction of a service provider 206, the interface or website and a service buyer or user 202 of the interface or website may be shown. Flowchart 400 begins with a service provider 206 signing up on the website in step 402. As described above with respect to the service buyer 202, the service provider 206 may sign up, register with or log into the website in any manner known to one having ordinary skill in the art. At this time, the service provider 206 may also enter data relating to the identity of the service provider 206, her physical location and the costs associated with her service. Additionally the service provider 206 may include information and examples regarding the type of work she does, as well as any other data related to her work. Depending on the type of service provider 206, different types of information may be provided. For a service provider 206 in the masonry industry, the information provided on the website may include photographs of their previous work or projects, for example. For an attorney or paralegal, the information provided on the website may include their curriculum vitae as well as examples of services they have performed for past clients. Additionally, each service provider 206 may include a link to a website that they or their company maintains. Note that while service providers (and service buyers) are assumed to be individuals for illustrative purposes herein, a service provider (or service buyer) can also be a group of individuals or an entity, such as but not limited to individuals in a company wherein the company is treated as the service provider (or service buyer).

After a potential service buyer 202 performs a search, such as that described with respect to FIG. 3, a service provider's 206 name may be returned as part of the search results in step 404, provided that the service provider 206 fits the criteria that the service buyer is seeking. Again, similar to that described in FIG. 3, a listing of service providers 206 may appear as results of the service buyer's search, and the ordering of the service providers 206 may be performed in any manner discussed herein, such as ordering the results of the search through the use of the average hourly value rating or another rating.

After the user 202 of the website selects and contacts a service provider 206, in step 406, a particular service provider 206 may accept a job and perform the service, in step 408, desired by the user 202. Following the completion of the job or service and the input of the website user's 202 feedback and rating data in to the website, the website can tabulate a revised average hourly value rating or other form of rating for the service provider 206 and update the service provider's rating in step 410.

As described with respect to FIGS. 2-4, a variety of systems, methods and algorithms are envisioned which may be used to rate and rank the service providers utilizing the interface. These ratings and rankings may be used both internally, i.e. within a database housing service provider information, and externally, i.e. displayed as part of a search result or displayed in any other listing of service providers.

In one exemplary embodiment related to FIGS. 2-4, the use of hourly value or other monetary value-related methodologies may be used as part of a rating and ranking system. At the completion of a project, a service buyer 202 may assign a monetary value to the services they received. The data and ratings on a particular job can be averaged or otherwise aggregated with such data and ratings on other jobs to calculate an aggregate score, such as an “average hourly value rating” score that can be assigned to a service provider 206. Then, following the receipt of new data and ratings from a service buyer, the average hourly value rating of the service provider may be updated. Thus, in a further embodiment, the method and system can attempt to discern the market value for the service or services provided by a service provider by aggregating the value service buyers place on the service provider's service. Therefore, unlike other ratings systems where a simple numerical rating (e.g. 1-10 or 1-100) or letter rating (e.g. A-F) is assigned, potential service buyers 202 utilizing this system will be aware of the collective value placed by past service buyers on the service provider's services which may be a close approximation of the market value or effective market value of the services provided by a service provider 206.

In a further exemplary embodiment, the monetary value that a service buyer assigns to the service provider 206 in step 316 of FIG. 3 could be the maximum hourly fee or maximum total amount of money that the buyer 202 would have been willing to pay had he, prior to negotiating the fee with the service provider, had the benefit of hindsight and the knowledge of the exact nature and quality of the services that he would receive. The buyer 202 may assign these values to the service provider's 206 service regardless of what the agreed upon price before the job started or the final price after the job, if there was any variance between the two. The amount assigned may also be more, less or equal to the amount actually paid by the buyer 202 for the service or services. Thus, a value of the services received in the opinion of the buyer 202 may be determined.

If the amount assigned by the buyer 202 to the provider 206 is expressed as a value per hour worked or billed, the amount may be referred to as an “hourly value rating.” An average hourly value rating for a service provider 206 may average or otherwise aggregate through a variety of methods each hourly value rating or a certain number of hourly value ratings received by that service provider. The average hourly value rating can therefore serve as a barometer of the collective value that service buyers 202 place on the work of a service provider 206. Further, prospective service buyers 202 may compare different service providers 206 against each other more easily by comparing their respective applicable average hourly value ratings. Also, a service provider 206 can have multiple average hourly value ratings For example, if the service provider 206 performs jobs in several job categories, he or she may have a different average hourly value rating score for each category of job wherein only the ratings received on jobs within the particular category would be aggregated for purposes of calculating the applicable average hourly value rating.

The “hourly value ratings” and “average hourly value ratings” as described above are exemplary and other monetary value ratings may be used. Furthermore, such monetary value ratings may be standardized through various measures of output, in addition to or in place of per hour worked or hour billed.

In addition to collecting value ratings data, the system, in steps 316 and 410, may collect additional information about the service or job that the service provider 206 gave to the service buyer 202. For example, the system may collect data pertaining to the actual hourly fee the service provider 206 charged, the total amount paid to the service provider 206 and the amount of hours worked or billed by the service provider 206. This data may or may not be accessible to other website users 202, depending on the desired application of the website. In addition, for each particular job, the hourly value rating submitted by the buyer 202 may be compared to the actual hourly fee, for example, to ascertain another performance metric. In this exemplary embodiment, if a particular job is performed by the service provider 206 at an hourly fee of $30 per hour worked or billed, but the service buyer 202, after the completion of the service, believes the completed service was worth a higher monetary value than he or she paid, they may give the service provider 206 a hourly value rating of $45 per hour. The hourly value rating divided by the actual hourly fee for that job would be therefore 1.5 (i.e. 150%). This score may be another tool or metric that has value to the users 202 of the website insofar as they can easily see and determine who provides the most service per dollar charged.

In yet another exemplary embodiment, if an hourly fee is not explicitly set forth in the agreement between a service provider 206 and the service buyer 202, the hourly fee for that job can be ascertained by eliminating the non-labor costs from the total amount paid for the service. This amount can then be divided by the amount of hours actually worked by the service provider 206. For example, if a bathroom renovation project was completed in 90 hours for a total cost of $20,000, but $11,000 of the total cost was non-labor (such as parts or supplies), the hourly fee could be computed as [($20,000−$11,000)/90 hours]=$100 per hour. Therefore, in these situations, after the service is completed, an hourly value rating may not be immediately assigned by the service buyer 202 either. Instead, assuming fixed non-labor costs, the service buyer 202 can be asked in step 316 to calculate the maximum total amount of money, in hindsight, that the service buyer 202 would have been willing to pay the service provider 206 had the buyer 202 had complete knowledge beforehand of the services that would be provided. If, in the example above, the service buyer 202 would have been willing to pay $18,000, the hourly value rating could be calculated as [($18,000−$11,000)/90 hours]=$77.78 per hour.

In a further exemplary embodiment, a monetary value-related performance metric may be calculated even if data pertaining to the actual number of hours worked or billed by the service provider 206 are not readily available. In scenarios such as this, a monetary value-related performance metric may still be obtained through a comparison of the value to the service buyer 202 of the services received and the amount paid for those services. For example, assume the actual total amount paid for a job, less non-labor costs, was $1500. However, if, in hindsight, the maximum total amount the service buyer would have been willing to pay for the service is $750, the metric could be calculated as $750/$1500=0.5 (or 50%). The average or other aggregate value of such a metric received by a service provider 206 after performing several jobs and receiving rating metrics of this type would be valuable for the comparison purposes of potential service buyers 202. This is, however, just one exemplary embodiment and it may often be assumed that an hourly value rating will be ascertainable from the data provided for most services following the completion of the service.

The hourly value rating, as described above, on a particular job may be aggregated with other such scores received by a service provider on other jobs to generate an average hourly value rating. With more data, the average hourly value rating may then begin to closely approximate the true value or market value for a specific service provider's services. Thus, in step 306 of FIG. 3, a potential service buyer 202 may be able to compare potential service providers 206 based upon this data more easily than if service providers 206 were merely assigned a non-monetary value based subjective numerical rating (e.g. a scale from 1-10). Also, while it is envisioned that service buyers 202 may not be under an obligation to hire a particular service provider 206 at the exact wage or hourly fee as the service provider's 206 then-prevailing average hourly value rating, as additional hourly value ratings data is collected on jobs, the actual wage or hourly fee that the service provider is able to charge (as freely bargained between the buyer 202 and the provider 206) may begin to closely approximate the provider's then-prevailing average hourly value rating. However, should a service provider 206 perform at an increasingly higher level, it is likely that her average hourly value rating will generally increase over time. Alternatively, if a service provider 206 performs at a level below their then-prevailing average hourly value rating, her average hourly value rating will likely decrease over time.

In a further exemplary embodiment, averages of the comparative data with respect to hourly value ratings as compared to actual fees, as described above, may also provide useful data as to whether a service provider 206 typically over-performs or under-performs. In addition, rather than merely utilizing simple averages in computing the average hourly value ratings, other methodologies may be employed such that the average hourly value rating applicable to a service provider 206 more closely approximates the true market value for a particular service provider's services.

One of many examples that may be used to compute an average hourly value rating applicable to a service provider 206 is as follows. Here, weighted averages may be used in such a manner that hourly value ratings received on certain jobs may be weighted more than others in computing the service provider's average hourly value rating. Thus, in one exemplary embodiment, relative total compensation amounts may play a role in weighting certain jobs more than others when computing the average hourly value rating applicable to the service provider 206. In one example, a job that requires more total man-hours and/or where a greater total amount was paid may be given more weight in aggregating an hourly value rating than a job that required less labor and/or a lesser amount was paid. An example calculation of a weighted average system to determine an average hourly value rating could be enacted as follows. In this example, from step 410 of FIG. 4, a service provider 206 receives an hourly value rating of $55 per hour on a job where he received $2000 in total compensation and an hourly value rating of $72 per hour on a job where he received $200 in total compensation. Thus, one exemplary weighted average hourly value rating with respect to these two jobs may be: [($55/hour×2000)+($72/hour×200)]/2200=$56.55.

In yet another exemplary embodiment, a system may be implemented whereby jobs receive different weightings in determining the average hourly value rating such as, for example, depending upon when the job was performed. For example, jobs performed in the more distant past may receive less weight as compared to jobs performed more recently. Any one of a number of different methods may be used to implement this exemplary weighting system. For example, the system could be such that for each month that passes after the completion of a job, the hourly value rating with respect to that job is weighted progressively less in computing the average hourly value rating of the service provider 206 who performed the job. Additionally, after a predetermined period of time, such as five years, an hourly value rating may no longer be taken into account with respect to the calculation of the average hourly value rating. Thus, in computing the average hourly value rating, such a system would assign a greater weight to jobs completed more recently and less weight to jobs performed in the past. Thus the average hourly value rating of a service provider 206 may be current and up to date. Further, the average hourly value rating would not be skewed by older jobs that may or may not have a bearing on the present function or capabilities of the service provider 206. This can allow for a more reliable measure of the current market value of a service provider's services 206. Additionally, for a service provider 206 who may have received a low hourly value rating on a job in the past, the service buyer 206 may be incentivized to perform additional jobs at a higher level in order to decrease the weighting of the earlier poor score. As a further exemplary embodiment, the system may utilize a method whereby not only would the weight assigned to a particular job when computing the average hourly value rating decrease as more time elapses since the job was performed, but the average hourly value rating may decrease absolutely (i.e. decreases to $0/hr or just a rating of 0) if a service provider 206 has not performed a predetermined amount of jobs or predetermined dollar amount of work in a predetermined amount of time. Such a system may provide an incentive for service providers 206 to perform jobs through the website or interface on a regular basis.

In one example of the above embodiments related to FIGS. 2-4, in weighting a particular ratings score applicable to a job when calculating the average hourly rating, a score can be multiplied by 1 if it was performed within the last year, multiplied by 0.8 if it was between 1-2 years ago, 0.6 if it was between 2-3 years ago, 0.4 if it was between 3-4 years ago, 0.2 if it was between 4-5 years ago and 0.0 if it was over 5 years ago. This is just one exemplary method, however, and any other factors or periods of time could be used to diminish the effect of a rating over time. Furthermore, the system could weight ratings in such a manner that if a service provider 206 turns down jobs or remains idle with respect to the website for a predetermined amount of time, a penalty may be assessed against the average hourly value rating score. Therefore, the overall values of the ratings could decrease absolutely, thus providing further incentive for service providers to perform jobs through the system regularly. Still other exemplary embodiments may apply a greater weight to more recent jobs or assign more value to tasks completed closer to the present, thus emulating the result above whereby older jobs are given a lesser weighting or absolute value.

In yet another exemplary embodiment of FIGS. 2-4, the system may incorporate a method whereby the effects of outlier or anomalistic scores may be lessened when computing the average hourly value rating. For example, if the hourly value ratings received by a service provider 206 are all generally within a small range of each other with the exception of a few outliers, as measured through statistical techniques, such outlier hourly value ratings may be weighted less or totally disregarded in computing that service provider's average hourly value rating.

In yet another exemplary embodiment of FIGS. 2 and 3, the actual wages or fees received by a service provider 206 as well as the hourly value ratings of the service provider 206 may be taken into account when computing a service provider's average hourly value rating. For example, the average hourly value rating may be a weighted average that takes into account both the actual wages and the hourly value ratings received for their jobs performed.

In yet another exemplary embodiment, the average hourly value rating may be a constantly adjusting value rather than a true average. For example, after the first job is completed by a service provider 206, the average hourly value rating may equal the actual hourly fee earned by the service provider 206 for that particular job. Additionally, the score may be influenced to some extent by the hourly value rating received by the first job. Then, for every job thereafter, there may be a limit as to how much the average hourly value rating can adjust for a single job. In other words, a limit could be placed on the amount of fluctuation of the average hourly value rating from job to job. In this example, the system may set the initial average hourly value rating for a service provider at $15 per hour. This score can represent either the simple or weighted average of the actual hourly fee and the hourly value rating earned on the service provider's first job through the system, or simply the hourly fee earned on the service provider's 206 first job. The system may then put a limit or cap on how much the average hourly value rating can adjust after a single job. In this example, the system may be such that the maximum adjustment after a single job is $5 per hour. Thus, whether the service provider 206 receives a score of $30 per hour or $500 per hour on their second job, the maximum that the service provider's average hourly value rating would be after the second job would be $20 per hour. Similarly, if the service provider 206 received an hourly value rating that was significantly below their average hourly value rating on the second job, their average hourly value rating could only drop to $10 per hour in this example. Further embodiments may incorporate algorithms that limit the amount that the average hourly value rating can be influenced by a single score, while also allowing for more adjustment if an individual hourly value rating varies more rather than less from the then-prevailing average hourly value rating. Additionally, other factors may be taken into account for a particular job, such as the total compensation received on that job. Thus, in some embodiments, the average hourly value rating may not represent a true average, weighted or otherwise, but may rather represent a moving value that adjusts incrementally based upon the last hourly value rating received when compared to the service provider's then-prevailing average hourly value rating.

In a further embodiment of FIGS. 2 and 3, regardless of a service provider's then-prevailing average hourly value rating, a service provider may be able to set an hourly fee or total fee at or above which they would be interested in performing services. For example, if a service provider 206 has an average hourly value rating of $55 per hour, she may provide a listing that indicates that she would be interested in performing services for an hourly fee of $40 per hour and above. Additionally, assuming the service provider 206 meets all of the other search criteria provided by a potential service buyer 202, the service providers 206 who are willing to work for an hourly fee at or below the amount specified by the potential service buyer would appear in the search result listings along with the other individuals who match the search criteria.

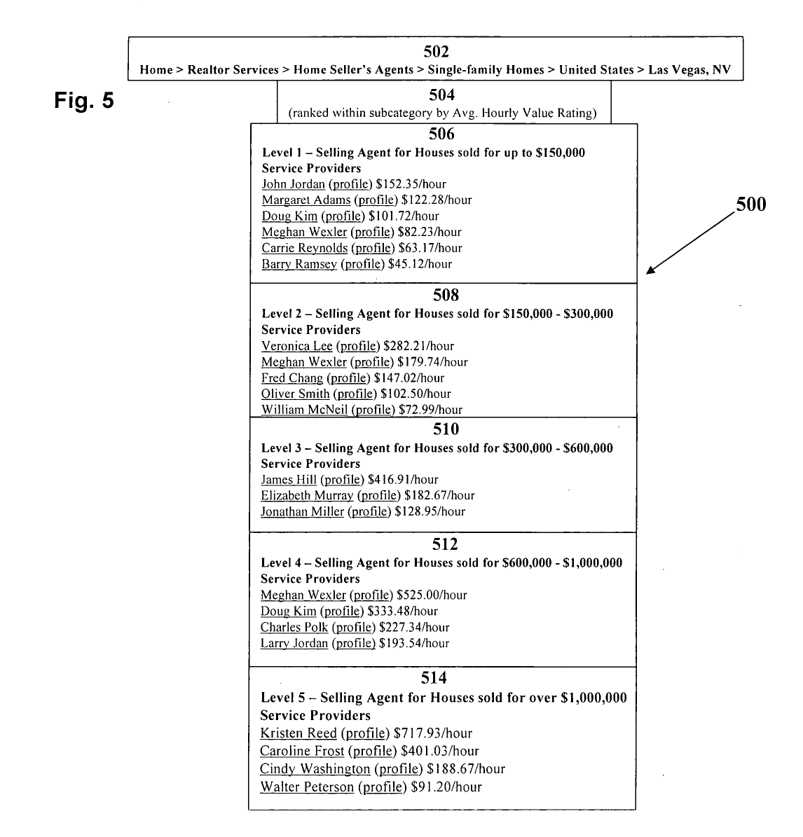

The exemplary embodiment shown in FIG. 5 employs some of the above-discussed systems and methods. Output 500 shows the results of a search performed by a potential service provider, such as in step 304 of FIG. 3. As shown in this embodiment, the search criteria has been broken down in box 502 from a home page where a search can take place, to realtor services, then to home seller's agents, then to single-family homes, then to the United States and then to the specific geographical region of Las Vegas, Nev. Box 504 then indicates that the results of the search are being shown as ranked within a subcategory by the average hourly value ratings of the service providers. The system then divides the pertinent results of the search into sub-categories for ease of browsing by the potential service buyer. In this example, box 506 contains selling agents for houses sold for up to $150,000, box 508 contains selling agents for houses sold for between $150,000 and $300,000, box 510 contains selling agents for houses sold for between $300,000 and $600,000, box 512 contains selling agents for houses sold for between $600,000 and $1,000,000 and box 514 contains selling agents for houses sold for over $1,000,000. While some boxes list more results than others, the number of service providers returned by the search may be tailored by the user of the website. Additionally, if there are more service providers for one category or one subcategory, a hyperlink to see more results can be available to the user.

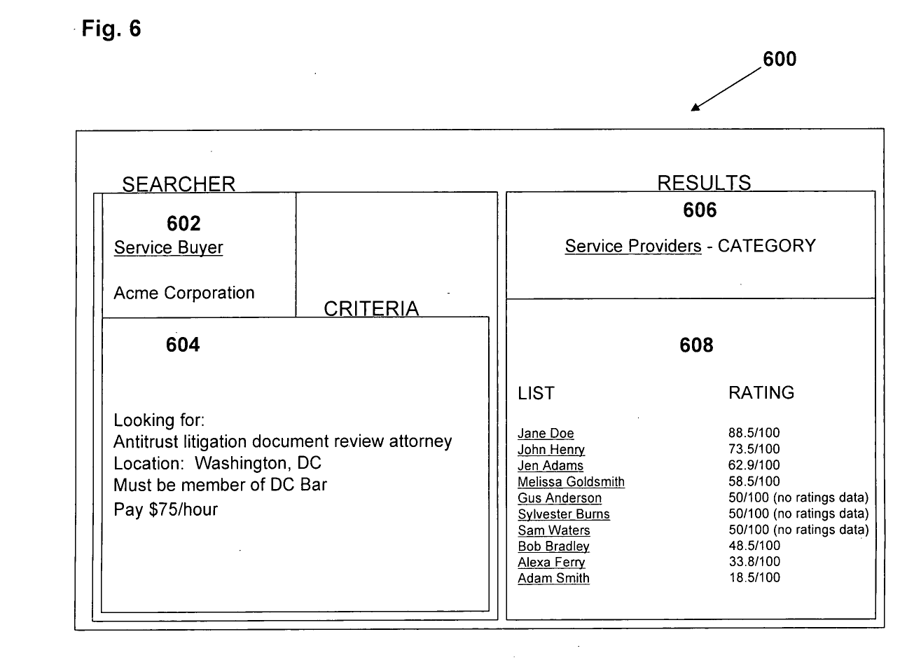

In another exemplary embodiment, another ratings system may be used separately from an hourly value rating system or in conjunction with an hourly value rating system. In this embodiment, as shown in FIG. 6, a candidate matching system 600 can be used to return relevant search result listings when a potential service buyer is searching for a service provider 606 that meets his or her search parameters. Similar to the above exemplary embodiment and FIG. 2, a service buyer 602 using the system 600 can enter a variety of search criteria 604. After a search is performed, an output screen listing the category 606 of results and the search results 608 can be returned from a database.

Using a similar strategy as that shown with respect to the flowchart in FIG. 3 in steps 302-316, a service buyer 602 may determine that he wishes to have a service performed. Thus, the service buyer 602 may access a website and perform a search using any of a variety of search criteria. After a listing of potential service providers 606 is returned, the service buyer 602 may obtain more information on the service providers 606 based upon profile or other information found on the website. The service buyer 602 may then offer a job to a service provider 606, the service provider 606 may perform the job and job performance data may be collected through the system 600. The website may then utilize the job performance data by applying a rating to the service provider's 606 performance after the completion of the job.

Additionally, similar to that described with respect to the flowchart in FIG. 4, steps 402-410, a service provider 606 may make himself accessible to the public by registering on a website. The service provider 606 can input information regarding desired jobs and other profile information, as described in part above. The service provider 606 may then be returned amongst the search results that are obtained by users 602 of the website. The service provider 606 may then be offered a job by a user 602 of the website and may then perform the job. Finally, similar to the above, job data can be collected and a rating assigned to the service provider 606 after the completion of the job.

In addition to the previously noted factors having an effect on the weight given a particular hourly value rating in computing a service provider's average hourly value rating as described above, the past experiences of the service buyers 602 who provide the individual hourly value rating scores may affect the weight given such score in computing the service provider's 606 applicable average hourly value rating score. For example, in another exemplary embodiment, rather than utilizing a simple average, the average hourly value rating score can be a weighted average based, in part, on the rating capability or experience of the service buyers 602. The weight given a particular hourly value rating may be adjusted through the use of “trust adjustments” or other similar methods. The “trust adjustment”, as defined herein, would adjust the weighting given a particular rating score in computing the service provider's average or aggregate rating value depending on the past experience of the service buyer 602 at issue, such that the scores provide by certain service buyers 602 would more significantly affect a service provider's 606 average rating score than others. For example, if a service buyer 602 has done a predetermined amount of business through the facilitating website, if a service buyer 602 has been a member of the website community for a long time, or if a service buyer 602 is otherwise well trusted or marked in good standing with the facilitating website, the service buyer's 602 scores may be assigned a higher trust adjustment weighting and therefore, all else being equal, be weighted more when determining the average rating to be given a service provider 606. Thus, the service provider's 606 average hourly value rating or ratings will be more influenced by the service buyer 602 with the high trust adjustment than a corresponding service buyer 602 with a lesser or unassigned trust adjustment. The trust adjustment may be incorporated into any type of ratings system used with the interface as well as combined with other methodologies to determine the weighting of individual scores in computing aggregate or average values such as the average hourly value rating discussed previously.

In a further exemplary embodiment, a trust adjustment may be determined through the use of any of a variety of factors. A higher trust adjustment may be given to scores given by users 602 of the website who, based upon their past track record with the website, give hourly value ratings to service providers 606 that tend to predict or correlate closely to the hourly value ratings that such service providers 606 receive on future jobs for other service buyers. For example, the trust adjustment could be based on the average rating scores or average hourly value ratings given for future jobs in the month, year, etc., after the scores are given by the particular service buyer 602. Additionally, the correlation could be made with respect to ratings given in jobs in the same or related job categories or subcategories. However, rating a service provider 606 close to the prevailing, readily accessible average rating already given to that service provider 606 will not necessarily result in a higher trust adjustment for a user of the website. Statistical techniques can be employed such that the trust adjustment weighting can take into account the tendency of the scores given by the service buyer to correlate with future scores received by the service provider while diminishing or disregarding the value of correlation merely with past scores. In this way, this methodology can attempt to give greater weight to the scores of service buyers 602 who give scores that tend to be predictive of scores that the service provider 606 will receive on future jobs. Thus, even with respect to service providers 606 who have yet to work more than a few jobs, the average hourly value scores of the service provider 606 may be closer to what they would be given a larger sample size. This is a result of the scores given by service buyers 602 who give more predictive scores having a more significant effect on the rating or ratings of the service provider 606 while the scores of service buyers 602 who give less predictive scores will have a less significant effect on the rating or ratings of the service provider 606. One result of this methodology is that the effect of scores given by service buyers 602 who do not have much experience using the system or service buyers 602 who tend to give outlier ratings will be lessened. Therefore, a more accurate rating system may be accomplished even where the sample size of ratings given to a particular service provider 606 may be small.

Further exemplary embodiments of a trust adjustment can utilize different components or factors. For example, the trust adjustment may take into account whether a service buyer 602 has more experience in utilizing the service of service providers 606 relative to others on the facilitating website or the amount of experience a service buyer has in a particular category or subcategory. Additionally, the trust adjustment to be applied a particular rating score could be affected by the dollar volume or amount of transactions conducted by the service buyer who gave such score. Also, the trust adjustment could be adjusted based upon how long a service buyer 602 has been a user of the facilitating website or a combination of any or all of these factors and any other factors that may be utilized.

A service buyer 602 who uses the system may also be incentivized to provide more accurate or predictive scores. Thus, in addition to having a higher trust adjustment for providing accurate scores for purposes of weighting such scores in applicable averages which will benefit the system on the whole, a party 602 providing such ratings could receive a monetary or other award for having a high trust adjustment score and providing accurate, predictive scores. Any award could also be on a sliding scale, such that, for example, the more accurate or predictive the scores given by a service buyer 602 and the more often a service buyer 602 gives accurate or predictive scores, the greater the incentive or reward. Further, in addition to monetary rewards, any other type of incentive or reward may be provided, such as access to additional website tools, preferred access, or reduced commissions, rates, or fees on future jobs.

Using any of the individual factors either alone or in combination, a formula or formulas may be used to calculate the trust adjustment for a service buyer 602. The formula or formulas may be changed or evolve over time. Additionally, other mechanisms may be used such that the ratings given by certain service buyers 602 are given more weight than rating scores given by other service buyers 602 who are not deemed to have the same level of expertise and/or predictive value in rating service provider performance through the website. Additionally, the trust adjustments applicable to service buyers 602 may or may not be readily viewable by the users of the website, including both service providers 606 and service buyers.

One example of determining a trust adjustment for a service buyer assumes that buyers who have transacted more business through the website will have their scores weighted more than buyers who have transacted less business. Here, assume that a first buyer has done between $50,000 and $100,000 worth of business hiring attorneys through the system while a second buyer has done less than $5000 worth of business hiring attorneys through the system. As a result, for example, the first buyer may have the ratings he assigns to service providers weighted by a factor of 5, whereas the second buyer can have his ratings weighted by a factor of 1.5. Therefore, if the first service buyer and the second service buyer hired the same attorney to perform work and the jobs were otherwise identical, and the first service buyer gave the attorney an average hourly value rating of $90 while the second service buyer gave the attorney a rating of $50, the average hourly value rating score for the two jobs could be calculated as follows:

[($90×5)+($50×1.5)]/6.5=$80.77

### As seen in the above results, the rating of the first service buyer will affect the average rating score of the service provider much more significantly than the rating of the second service buyer.

In further exemplary embodiments, other adjustments may be made to the ratings by a service buyer 602 based upon statistical analysis of how a service buyer 602 tends to vote or rate. For example, if a service buyer 602 tends to give scores that are higher or lower than the average scores that service providers 606 who have done work for the service buyer 602 receive from other service buyers 602 in future jobs, the ratings scores given by the service buyer 602 may be adjusted to reflect that fact. Thus, the scores given by a traditionally high scorer may be adjusted downwards while the scores of a traditionally low scorer may be adjusted upwards.

In another exemplary embodiment, a service provider 606 may be given a rating award for meeting certain performance criteria. The system could also allow a service provider 606 who meets some criteria to be able to expunge or otherwise decrease the weighting of certain rating data related to past underperformance or unfavorable performance. For example, if a service provider 606 has completed five jobs through the website, that service provider 606 could elect to expunge all data with respect to one past job in which he or she received the lowest rating, such that the job in question did not involve anything more than normal underperformance (i.e. the service provider did not commit fraud on the buyer).

Any number of other statistical or other techniques may be utilized to provide an average hourly value rating for a service provider that is more reflective of the actual value that the service provider, on average, provides. For example, the system could be such that outlier scores are disregarded when the sample size is below a predetermined value, but that all scores, including outliers, are taken into account after a certain number of jobs have been performed. Furthermore, any one or more of the techniques illustrated herein can be combined in any weighting system utilized. One result with such techniques is for the average hourly value rating applicable to a service provider's work to reflect the average value score that the service provider would receive were he to perform an infinite number of jobs such that the outlier scores and service buyer errors balance each other out and the true value provided is revealed. Given small sample sizes and the possibility that service buyer biases and inaccuracies may affect the scores given, various techniques may be employed to mitigate such effects such that the average hourly value rating is more reflective of the actual value provided, on average.

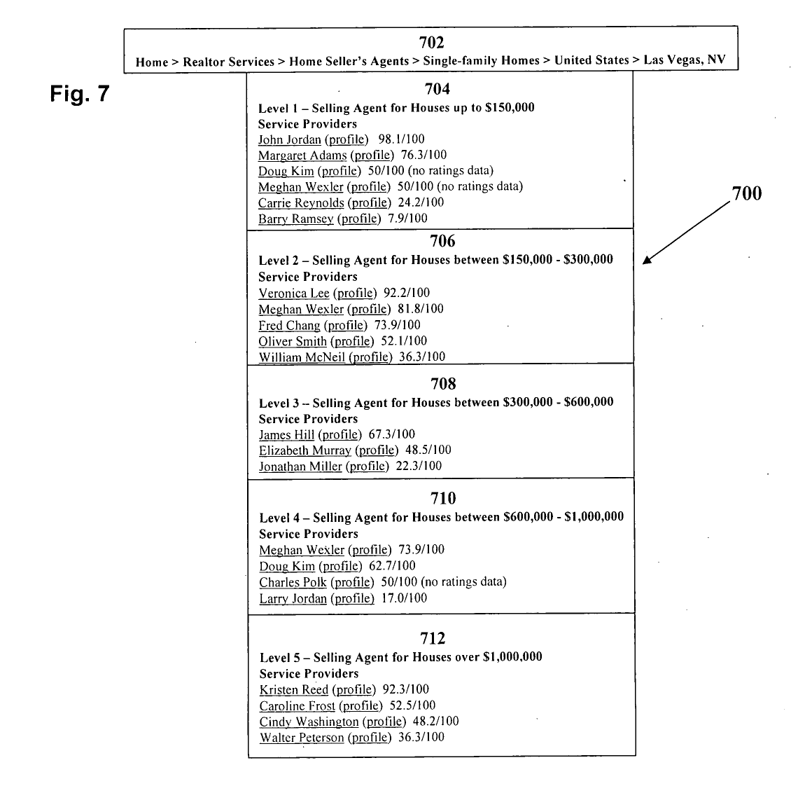

FIG. 7 represents an exemplary output of a potential service buyer's 602 search, as described above with respect to step 304 of FIG. 3. This exemplary figure Similar to FIG. 5, this figure can incorporate the data stored following the completion of a job by a service provider and any of the weighting factors on both the service provider 606 and service buyer 602 discussed in the above embodiments. FIG. 7 includes an exemplary layout 700 of the search results of a search by a prospective service buyer 602. In 702, the search criteria of the prospective service buyer 602 can be seen. Here, the prospective service buyer 602 searched the category of Home and the subcategories of Realtor Services, Home Seller's Agents, Single-family Homes, United States and Las Vegas, Nev. The results of this search have been divided into five different categories 704-712. These categories may be default categories based upon the search criteria or may be selected by the prospective service buyer as part of the search criteria or as their preferred layout of results. These exemplary categories are, however, specific to selling agents for houses in Las Vegas, Nev. Other geographic areas may have different results or a prospective service buyer may select to divide the results into different dollar amount categories. However, in FIG. 7, the categories have been divided into level 1 (704), selling agents for houses up to $150,000, level 2 (706), selling agents for houses between $150,000-$300,000, level 3 (708), selling agents for houses between $300,000-$600,000, level 4 (710), selling agents for houses between $600,000-$1,000,000 and level 5 (712), selling agents for houses over $1,000,000. As described above, search results based on other criteria may include a default categorization scheme and may be divided in any other of a variety of categories or levels.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for rating, comprising:
housing information about a plurality of first parties in a database;
searching, by any second party, for a service offered by one of the plurality of first parties;
accessing, by a second party, the information about the plurality of first parties;
offering a job to one of the first parties by the second party;
performing, by the one of the first parties, the job for the second party;
inputting data regarding the job performed by the one of the first parties into the database by the second party; and
assigning a rating to the one of the first parties who performed the job based upon the inputted data regarding the job and data about the second party for whom the job was performed.

2. The method of claim 1, further comprising:
accessing the information about the plurality of first parties through the Internet.

3. The method of claim 1, further comprising:
displaying a rating for each of the plurality of first parties accessed by the second party.

4. The method of claim 1, further comprising:
calculating the rating assigned to the one of the first parties by determining a monetary amount that the second party would have been willing to pay for the job performed by the first party, had the second party, at the time the fee was negotiated, had the benefit of hindsight and knowledge of the exact nature and quality of the job that would be performed.

5. The method of claim 4, wherein the monetary amount that the second party would have been willing to pay for the job performed is a maximum monetary amount.

6. The method of claim 4, wherein the rating assigned to the one of the first parties is provided as a monetary value rating per unit of output.

7. The method of claim 6 wherein the monetary value rating per unit of output is an hourly value rating per hour worked or billed.

8. The method of claim 4, wherein a plurality of ratings are aggregated for first parties across multiple jobs.

9. The method of claim 8, further comprising:
weighting the rating according to factors related to the job performed by the first party for the second party, a job history of the first party, and a job history of the second party, including a history of the second party in providing ratings to any first parties housed in the database.

10. The method of claim 4, wherein the rating given by the second party is given more weight in computing an aggregate rating value applicable to a first party after the second party has given a plurality of earlier ratings to other first parties housed in the database.

11. The method of claim 4, wherein a rating given by the second party is given more weight in computing an aggregate rating value applicable to the first party when past ratings given by the second party to first parties housed in the database were predictive of future ratings received by the first parties.

12. The method of claim 4, wherein an incentive is given to the second party to give ratings that are predictive of ratings received by the first party on future jobs.

13. The method of claim 4, wherein a rating given by a second party more recently is given more weight in computing an aggregate rating value applicable to a first party than a rating given an amount of time in the past.

14. The method of claim 1, wherein the rating assigned by the second party to the one of the first parties who performed the job is a numerical rating.

15. The method of claim 14, further comprising:
weighting the rating according to a job history of the second party, a job history of the first party, a length of the job performed by the first party for the second party and a price of the job paid by the second party to the first party.

16. The method of claim 15, wherein the rating given by the second party is given more weight in computing an aggregate rating value applicable to the first party if the second party has rated an amount of first parties housed in the database.

17. The method of claim 15, wherein the rating given by the second party is given more weight in computing an aggregate rating value applicable to the first party if the second party gives a rating that is predictive of future ratings given to the first party by other parties.

18. The method of claim 17, further comprising:
providing an incentive to the second party to give a rating that is predictive of future ratings given to the first party by other parties.

19. A system, comprising:
an online database housing information regarding a plurality of service providers;
an online interface that allows users to access the online database and contact service providers,
the online interface further having a search tool into which users can enter search criteria, the search tool returning search results that are rated and ranked according to data provided by users who previously obtained services from the service providers in the online database and other data regarding the service providers; and
a feedback input mechanism that allows users of the system to leave feedback regarding the service provider following the completion of a job, the feedback used as part of the data used in calculating a rating and ranking of an individual service provider.

20. The system of claim 19, wherein the rating is a maximum monetary amount per unit of output value that a user would have been willing to pay for the job completed by a service provider, given the benefit of hindsight and knowledge of the exact nature and quality of the work performed.

21. The system of claim 19, further comprising:
a weighting scheme that varies a weighting value of the rating given by a user in computing an aggregate rating of a service provider based upon aspects of the job completed by the service provider to which the rating relates.

22. The system of claim 19, further comprising:
a weighting scheme that varies a weighting value of the rating given by a user in computing an aggregate rating of a service provider based upon an accuracy assessment of previous ratings provided by the user.

23. The system of claim 19, wherein the users are given an incentive to provide ratings that are predictive of the future ratings given to a service provider.

24. A method of providing and rating services, comprising:
means for housing data regarding a plurality of service providers;
means for allowing a plurality service buyers to access and search the data regarding the plurality of service providers;
means for returning relevant search results to the plurality of service buyers;
means for communicating a job offer from a service buyer to a service provider;
means for a service buyer to accept and perform a job for the service buyer;
means for the service buyer to leave feedback data regarding a job performed by the service provider;
means for aggregating and weighting the feedback provided by the service buyer; and
means for calculating aggregate scores applicable to the service provider that take account feedback.

25. The method of providing and rating services of claim 24, further comprising:
means for providing the rating in the form of a monetary value per unit of output.

26. The method of providing and rating services of claim 24, further comprising:
means for determining if the feedback left by the service buyer is predictive of feedback to be given to the service provider by other service buyers in the future
means for determining the qualitative and quantitative nature of such predictive value through statistical techniques; and
means for providing an incentive to the service buyer to leave feedback to the service provider that is predictive of feedback to be given to that service provider by other service buyers in the future.
